(19) United States
(12) Patent Application Publication
(10) Pub. No.: US 2026/0145089 A1
(43) Pub. Date: May 28, 2026

(54) Systems and Methods for Multi-Domain Gamified Competition

(71) Applicants: Alicia Savage, San Francisco, CA (US); Felicia Savage, San Francisco, CA (US)

(72) Inventors: Alicia Savage, San Francisco, CA (US); Felicia Savage, San Francisco, CA (US)

(21) Appl. No.: 19/401,357

(22) Filed: Nov. 26, 2025

Related U.S. Application Data
(60) Provisional application No. 63/725,022, filed on Nov. 26, 2024.

(51) Int. Cl. A63F 13/828; A63F 13/537

(52) U.S. Cl. CPC A63F 13/828; A63F 13/537

(57) ABSTRACT

A system and method for administering a game in which live sports game is displayed and/or results retrieved, and a virtual game associated with the live sports game is established along with other game attributes of game play are combined to determine player scores a rankings.

### BACKGROUND

Fantasy sports games are known in which players in the fantasy league pick a roster of players comprising real world sports players to create virtual teams. The virtual teams then earn points based on the performance of the real-world players as physical games are played. However, such fantasy games are limited as the players of the virtual games select players and then obtain results. There is no physical participation in the game or way in which an actual player participates based on their own skill set.

### SUMMARY

Exemplary embodiments shown and described herein include systems and methods for multi-domain gamified competition that incorporates any combination of adaptive scoring, AI-driven evaluation, biometric health metrics, viewer interaction, benching penalty states, and/or optional immunity artifacts.

Exemplary embodiments of the game system and methods described herein permit players to select virtual teams and obtain scores based on the performance of real world athletes. This permits players that have limited athletic skill to complete at a competitive sports level.

However, fantasy only sports games do not encourage the actual participation of the players and there is no contribution of the player themselves except in the selection of players based on personal preference or statistics associated with the player. Exemplary embodiments of the game systems and methods described herein combine skills of the players to generate a complete score for a player in the virtual game.

Exemplary embodiments of the game system and method described herein permit players to select team members to compete in a virtual game. The team members may be based on real world players of a given sport in which the real-world players participate in physical games. After each physical game and/or other physical events, the team member may receive points associated with the game statistics for that member. The player of the game system described herein may thereafter earn points based on the points of the respective team members they selected for their virtual team.

Exemplary embodiments of the game system and method described herein permit players to participate in secondary game activities in which the player competes against other players that have created their own virtual team. The players may be awarded points depending on the rankings of the players'participation in the secondary game activities.

Exemplary embodiments of the game system and method described herein may permit a combination of a total score of the players to include those scores based on the selection of virtual team members and/or in the points earned through the secondary game activities. A player with the highest total score may win the game.

### DRAWINGS

FIG. 1 illustrates an exemplary flow diagram for performing the game method according to embodiments described herein.

FIG. 2 illustrates an exemplary block diagram of the system 200 shown and described herein.

FIG. 3 illustrates an exemplary system for performing the game according to embodiments described herein.

### DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In this document, when terms such as “first” and “second” are used to modify a noun, such use is simply intended to distinguish one item from another and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

The term “data” may be retrieved, stored or modified by processors in accordance with a set of instructions. For instance, although the claimed subject matter is not limited by any particular data structure, the data may be stored in computing device registers, in a relational database as a table having a plurality of different fields and records, XML documents or flat files. The data may also be formatted in any computing device-readable format.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards, optical data storage devices, solid-state drives (SSDs), cloud-based storage systems, distributed storage environments, or any other non-transitory storage medium capable of storing executable instructions or data. The computer readable medium can also be distributed in network-coupled computer systems so that the computer readable media may be stored and executed in a distributed fashion such as, e.g., by a telematics server or a Controller Area Network (CAN).

Exemplary embodiments of the game systems and methods described herein provide a processor configured to perform the functions described herein when computer instructions are executed by the processor. The exemplary system is configured to perform any combination of the following features:
Providing and displaying a user interface for selecting team members from a group of available team members
Providing and displaying a user interface for identifying one or more players to form a game team and create a virtual team with a combination of players and team members
Wherein the team members comprise identities of persons that play in a sport or other activity that are on teams and in a physical league
Wherein the players are physical people joining the game according to embodiments described herein
Receiving team member statistics for each of the available team member
Wherein the statistics associated with the team members are determined based on performance in one or more physical games played within the sport or other activity in the physical league
Determining a virtual score based on the statistics associated with each of the selected team member
Creating one or more team activities to be performed by one or more players
Determining a physical score from the results of the one or more team activities performed by the one or more players
Determining an overall team score from the virtual score and the physical score
Ranking the game team based on the overall team score

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. The drawings are diagrammatic and schematic representations of exemplary embodiments of the invention and are not limiting of the present invention nor are they necessarily drawn to scale.

Although embodiments of the invention may be described and illustrated herein in terms of sports teams, embodiments of this invention are not so limited but are additionally applicable to group activities or scored or ranked activities.

This invention relates to computational systems, gamified competition structures, interactive entertainment platforms, adaptive scoring systems, and multi-layer performance evaluation engines. Although embodiments shown and describe herein include mobile applications, other embodiments optionally include television formats, digital ecosystems, AI-driven evaluation systems, health/fitness monitoring, online competitive environments, and real-world challenge programs.

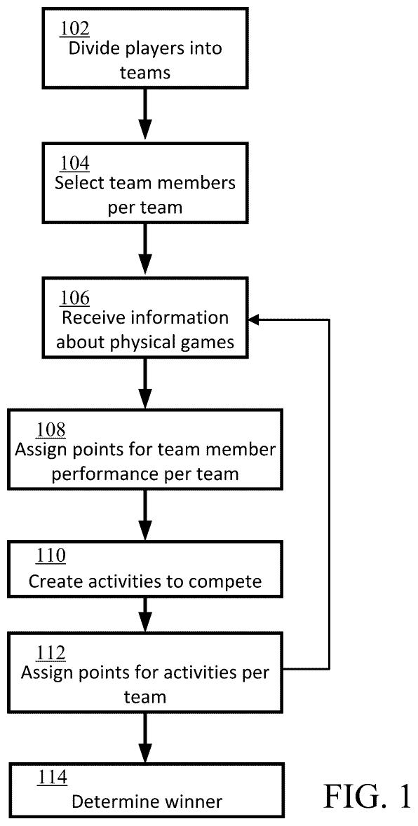

FIG. 1 illustrates an exemplary flow diagram for performing the game method according to embodiments described herein.

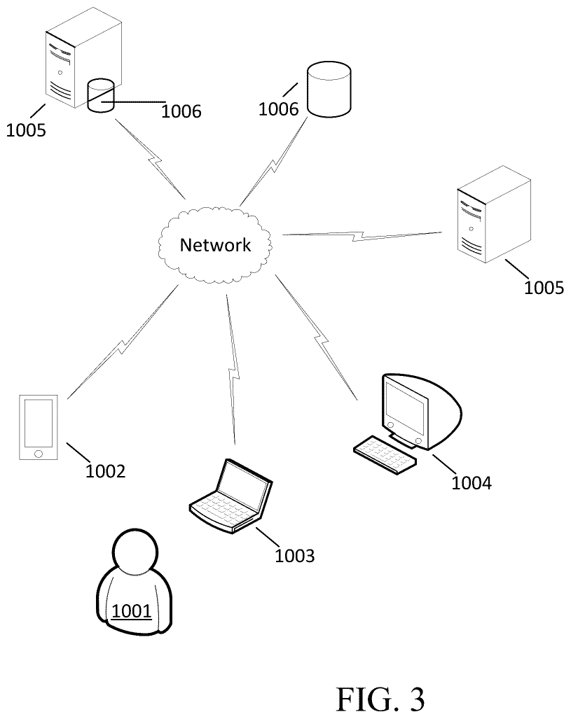

As described more fully herein and especially with respect to FIG. 3, exemplary embodiments of the game systems and methods described herein provide a processor configured to perform the functions described herein when computer instructions are executed by the processor. The exemplary system is configured to perform any combination of the functions described herein.

At step 102, a plurality of players is divided into teams. The players are physical people joining the game according to embodiments described herein.

In an exemplary embodiment, the system may be configured to provide and display a user interface to permit players to enter in information about the players. The user interface may permit players to select other players to form a league and/or the system may be configured to create leagues for unassigned or ungrouped players. Each player may define a team and/or one or more players may join together to act as a single team.

Once the players are grouped into leagues comprising one or more players defining one or more teams, the system at step 104 may permit teams to select one or more team members from a group of available team members.

The team members may comprise identities of people that play in a sport or other activity that are on teams and in a physical league.

In an exemplary embodiment, a roster of available team members may be identified to the one or more players of a league. The team, through the user interface of one or more of the players of the team, may be presented with the available team members and may select one or more of the available team members to create a virtual team of team members associated with each of the teams.

The system is configured to define a plurality of teams comprising a combination of team members defining a virtual team for each of the plurality of teams and one or more players permitted to select the team members of the virtual team.

At step 106, physical team members related to the available team members play their respective sport or activity on a periodic basis. Information about the respective activity or sport and performance of the physical team members is provided to and/or received by the system.

At step 108, the system is configured to use the information received about the respective activity or sport and/or about the performance of the physical team members and assign points for each team member of the available team members. The system is then configured to tally points per team based on the points assigned. In an exemplary embodiment, the receiving information about the respective activity or sport and/or about the performance of the physical team members may include receiving team member statistics for each of the available team members. In an exemplary embodiment, the statistics associated with the team members are determined based on performance in one or more physical games played within the sport or other activity in the physical league.

In an optional embodiment, the system may be configured to determine a virtual score based on the points assigned for team members performance per team and/or the statistics associated with each of the selected team member. The system may be configured to periodically update the virtual score associated with the performance of the team members as they perform in physical activities or sports.

An exemplary scoring system for the virtual score for the sport of football may be based on the position of the player and one or more performance attributes achieved by the player based on their position. For example, quarterbacks may obtain points based on the number of passing yards thrown, passing touchdowns, rushing yards, rushing touchdowns, interceptions, fumbles lost, fumbles lost for touchdowns. The player may be awarded positive points for good performance and negative points for poor performance.

At step 110, the system may be configured to receive, present, and/or create one or more team activities to be performed by one or more players.

In an exemplary embodiment, the system may be programmed with one or more team activities to be selected by one or more players. In an optional embodiment, the system may be configured to permit players to vote on one or more team activities. In an optional embodiment, the system may be configured to permit one or more players to define one or more team activities. In an optional embodiment, the system may be configured to define one user as a game commissioner, and the game commissioner may be permitted to define one or more team activities.

The players may then engage in one or more team activities. At step 112, the system may be configured to assign points for the performance of one or more team activities. In an exemplary embodiment, the system may be configured to determine a physical score from the results of the one or more team activities performed by the one or more players.

In an optional embodiment, the system may be configured to permit any combination of the performance of one or more activities by the players and/or one or more sports or other activities to be performed by the team members to obtain updated and/or cumulated physical and/or virtual scores per team.

At step 114, the system may be configured to combine the scores associated with each of the teams to determine a final team score for each team. The system, using the final team scores associated with each of the teams may be configured to determine a winner from the teams participating in the game. In an optional embodiment, the system may be configured to determine an overall team score from the virtual score and the physical score. In an optional embodiment, the system may be configured to rank the game team based on the overall team score.

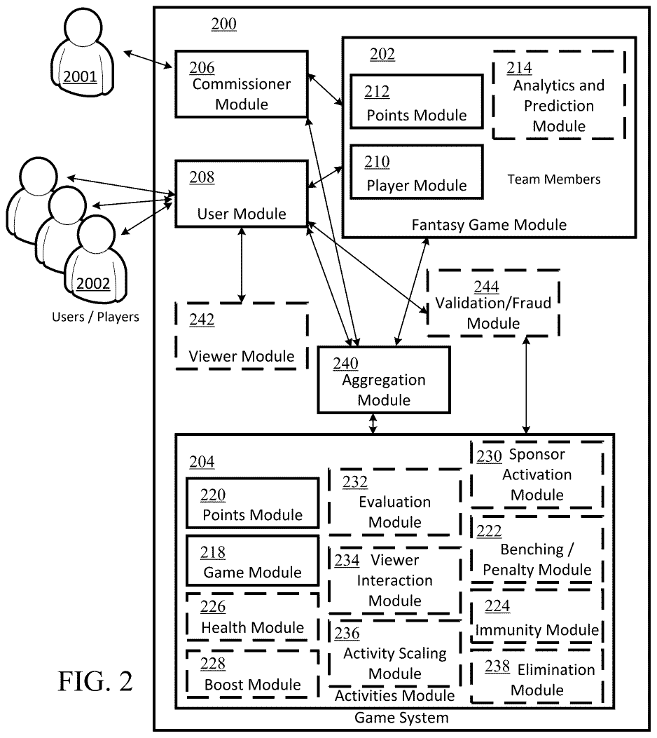

FIG. 2 illustrates an exemplary block diagram of the system 200 shown and described herein. Exemplary processes and modules that may be optional are illustrated in dashed lines. These options may be included and/or excluded to result in any combination of features. For example, for the exemplary embodiment in which a reality or celebrity show is incorporated, the viewer module 242 and viewer interaction modules 234 may be included. However, for a home version for a personal game, these modules may be inactive or not present.

As shown and described with respect to FIG. 2, the exemplary system is described in terms of individual modules. The term “module” refers to a set of computer-readable programming instructions, as executed by a processor, that cause the processor to perform one or more specified function(s). In addition, the terms “unit” and “module” described in the specification mean units for processing at least one function and/or operation and can be implemented by hardware components or software components or combinations thereof.

Although exemplary embodiments are described as using a plurality of units or modules to perform the exemplary process, it is understood that the exemplary processes may also be performed by one or plurality of modules. The separate modules are shown and described for illustrative purposes only. A module or unit may perform multiple functions such that a single module may actually perform and be considered as two modules as described herein. Additionally, it is understood that the term controller/control unit refers to a hardware device that includes a memory and a processor and is specifically programmed to execute the processes described herein. The memory is configured to store the modules, and the processor is specifically configured to execute these modules to perform one or more processes that are described further herein and below.

As illustrated, the system 200 may include a fantasy game module 202, an activities module 204, a commissioner module 206, and a user module 208. These modules may communicate with each other to perform the functions of the system described herein.

The fantasy game module 202 is configured to maintain the roster of available team members to be selected by individual teams within a league, track selections of team members associated with each team, track points associated with each team member, and optionally perform analytics and/or predictions on the respective team members. As described further herein, “track” is intended to be inclusive of any combination of receiving data, calculating data from received data, storing results of either received and/or calculated data, and any combination thereof. Data may be received from an external source, such as a user interface, sensors, electronic device coupled to the system, or internally such as from one or more modules shown and described herein.

Activities module 204 is configured to maintain the available activities that may be performed by players 2002, associate points for respective activities, track points associated with each player after and based on their performance of the activity, and optionally perform other functions as described herein.

Commissioner module 206 is configured to permit one or more users 2001 to act as an administrator over one or more leagues within the system. The commissioner module 206 may therefore provide a user interface to a user 2001 for receiving and/or providing data to the system.

The commissioner module 206 may be configured to permit a user 2001 to select or define one or more parameters of the system. For example, the commissioner module 206 may permit a user 2001 to make selections on available team members for selection by teams within the league, assign or select points associated within the fantasy game module 202 and/or the activities module 204, define the number of teams within the league, define the play duration and frequency, determine playoff rules and elimination criteria, select the presence or absence of optional features, such as, for example, functions of the boost module and/or health module.

User module 208 may be configured to permit a plurality of users 2002 to access the system 200 and provide and/or receive data from the system. The user module 208 may comprise a user interface that permits one or more users 2002 to receive or provide data to the system through one or more user input devices. For example, the user module 208 may present one or more users 2002 with a user interface providing information to the user, such as available team members for selection during a draft period, and making selections from the provided information, such as selecting a sub-set of team members from the available team members.

The fantasy game module 202 may include additional modules.

Player module 210 of the fantasy game module 202 may be configured to store a plurality of team members that the players may select to create a fantasy team. The player module 210 may be configured to associate a subset of the plurality of players to each of the players so that the players each include a unique set of team members to create individual fantasy teams.

In an exemplary embodiment, each player 2002 may select a subset of team members from the plurality of team members stored in the player module 210. Once a team member is selected by a player that team member can no longer be selected by another player.

Points module 212 of the fantasy game module may be configured to track points associated with the team members after their performance in one or more games during a period of time. As shown and described herein, a team member earns points for achieving certain objectives. For football, the team member may earn points for catching, running yards, interceptions, touch downs, field goals, etc.

The points module 212 may track points associated with individual team members and may accumulated points for the team members in each team of each of the players for team points.

Analytics and prediction module 202 may be configured to store statistics with respect to each of the team members. The analytics and prediction module 202 may use the stored statistics to make predictions about future performance of the one or more team members. The analytics and prediction module 214 may rank one or more team members relative to other team members in the same positions based on an anticipated points for each team member and/or based on past performance of each team member.

Game module 218 of the activities module 204 includes available options for the activities for the players to engage in to obtain additional points. The game module 218 may include instructions for the games and/or rules for how to select a game for each period.

Points module 220 of the activities module 204 may be configured to determine a set of points for each activity and store the resulting points for each player after the conclusion of each activity for the points earned for each player. The points module 220 may be configured to track points from a variety of modules awarding points.

In an exemplary embodiment, the points module 220 may provide a scoring system that assigns point values to player performance based on ranking within each activity. Each activity may produce points through a structured scoring table. For example, each place may be provided points, with points being increased between each place. As an example, first place may obtain 25 points, second place as 20 points, third place as 18 points, fourth place as 16 points, fifth place as 14 points, sixth place as 12 points, seventh place as 10 points, eighth place as 8 points, ninth place as 6 points, tenth place as 4 points. This point system is illustrative only and not limiting.

In an exemplary embodiment, the points module 220 may assign a place order and/or enhancement points based on any additional criteria. For example, the difficulty may change for players and harder activities may be given additional points and/or may increase place value compared to players performing less difficult difficulty. Other criteria that may be used to provide additional points and/or impact a place order for the players may include activity difficulty, time to complete an activity, adjusted obtained through analysis of an artificial intelligence engine, verified skill levels, viewer or sponsor boosts, or any combination thereof.

The activities module may include additional modules to assess additional points and/or influence place value for players of an activity. Exemplary embodiments of the system and method for multi-domain gamified competition may provide a unified scoring and competitive framework that integrates traditional fantasy points, activity points, boost points, health points, and conditional scoring states such as benching penalties and immunity artifacts, or combinations thereof. Exemplary embodiments of the systems and methods may enable dynamic scoring modulation using AI analysis, biometric data, viewer interactivity, and sponsor-controlled event activations. The system is applicable across mobile apps, television competitions, corporate environments, fitness ecosystems, educational programs, digital gaming, and real-world or virtual events.

Exemplary embodiments of the system and games shown and described herein may include an aggregation module 240 for combining points from various modules shown and described herein. Various points that may be combined include fantasy points from the fantasy game module 202, and one or more other points from the activities module 204. For example additional points may include activity points, boost points, health points, Points: Baseline metrics derived from standard scoring such as fantasy-sports scoring, time-based metrics, performance ratings, or any quantifiable outcome, benching points, immunity artifacts, or combinations thereof.

Traditional points may be a baseline metric derived from standard scoring such as fantasy sports scoring, time based metrics, performance ratings, or any quantifiable outcome.

Activity points may include challenge-based scoring derived from structured activities (‘activities’) using a rank-based or performance-scaled model.

Boost points may include additional points awarded through viewer participation, sponsor activities, or special events by the system.

Health points may include metrics derived from biometric inputs including step count, heart rate, sleep quality, hydration frequency, caloric burn, stress level, or combinations thereof.

Benching may include a penalty state wherein a player's ability to earn, retain, or accumulate points is temporarily restricted, suppressed, or nullified.

Immunity artifacts may include limited-use immunity artifact that overrides elimination or penalty outcomes for a scoring cycle for one or more players.

Activities may include any combination of structured physical, mental, digital, or creative task designed to generate measurable results used for scoring and ranking.

The activities module 204 may include an activity scaling module 236. The activities scaling module may assess a difficulty of an activity performed by a player. The higher the difficulty of the activity, the scaling module may be used to increase or assess the player's performance and increase the rank of the player as compared to players performing less difficult activities. The scaling module may also or alternatively be used to add additional points for more difficult activities. For example, the higher difficulty activities may yield elevated base points or provide a multiple to a base point system or may provide set point increases for different levels of difficulty.

The activities scaling module 236 may provide enhancements for players performing activities based on time to completion. Faster completion times may generate enhancements. For example, the activities scaling module may increase the player's ranking based on a lower time to complete, or additional or alternatively be used to add additional points for fast completion times. The scaling module may also or alternatively be used to add additional points for players that complete an activity in lower times. For example, the faster completion times may yield elevated base points or provide a multiple to a base point system or may provide set point increases for different levels of difficulty.

The activities scaling module 236 may provide enhancements for players performing activities based on skill level. Participants may demonstrate verified improvement or mastery. The higher skill level may earn additional points and/or effect the player ranking in performing the activities by increasing the ranking level.

An evaluation module 232 may include an artificial intelligence and/or machine learning assessment to adjust player's activities points and/or player's activity ranking. The machine engine, as either an artificial intelligence or machine learning or machine instruction may evaluate precision, consistency, creativity, safety, accuracy, form, strategy, or combinations thereof.

A sponsor activation module 230 may permit the actions of a third party to be used to add additional points and/or permit a sponsor to provide one or more benefits to one or more players. The player may obtain real-time or delayed enhancements that may adjust the player's points dynamically. The sponsor may also purchase or otherwise provide benefits to a player, such as in providing the immunity or other protections as shown and described herein.

The boost module 228 may be configured to award special badges/boosts to a player for performing certain achievements. For example, a player may receive badges for meeting certain criteria, such as, for example, being the fastest to complete an activity, performing the most difficult activity, achieving the most votes or views by spectators, or combinations thereof. The boost module 228 may track badges that may be used, such as for breaking a tie, convert to points, add points, or in other ways as shown and described herein.

Health module 226 may be configured to increase a player's ranking and/or add points based on health scores that may be obtained through biometric inputs. For example, the system may include one or more biometric sensors for tracking any combination of health data, such as, for example, heart rate, weight, temperature, blood pressure, blood oxygenation, etc. The players may be given enhancements based on the obtained health data. The enhancements may increase points if the player shows improved health and/or if the health data shows more strenuous activity. For example, if a player is working harder at an activity, them the player may be awarded additional points or may improve a ranking compared to those that are not working as hard. Alternatively or in addition, if the activity is the same for all players, the player showing better health metrics from the obtained health data may be awarded additional points or may improve a ranking as compared to those have worse health metrics.

Viewer Interaction Module 234 may be configured to permit viewers or spectators of the activity to add points and/or vote on players. The players may obtain additional points or improve rankings based on their performance of an activity as perceived by other players and/or spectators of the activity. Spectators and/or players may have access to the system and may enter rankings and/or feedback about the players, the activity, or a combination thereof. The viewer interaction module may also or alternatively receive feedback about an activity, may be used in selecting the activity, and/or may improve that ranking of or provide points to one or more players.

In an exemplary embodiment, the players may participate in activities as individual and/or as groups. In some configurations, players may participate in activities in groups. The system may implement one or more scoring methods to accommodate the individual and/or group participation. For example, each player may be given a team score based on the sum of individual scores; each player may earn their own score and receive the individual score within the team; only a top performer in a team is used to generate a team score; the team score may be generated as a weighted total from the individuals, such as a captain may generate a weighted multiplier compared to other players.

The system may include a benching/penalty module 222. The system may be configured to penalize one or more players for defined actions. Defined actions that result in a penalty may include any combination of late submissions, rule violations, detected integrity violations, skill regression, incomplete tasks, or viewer negative votes.

If one or more players within a group generates a penalty or benching event, the system may impose a penalty, such as a loss rank and/or reduction in points on the player and/or the group of players associated with the player. A benching/penalty may be imposed when a player does not follow instructions of an activity, does not perform within a certain amount of time, or other condition as imposed by the system and/or administrator.

The benching/penalty module 222 may identify one or more player as benched for a period of time. The one or more player indicated as benched suspends a player from participation for a period of time. The benched player may not accumulate a portion or all of their points or perform activities for a period of time. Benching may be triggered through performance failure, inconsistent detection from the evaluation module, viewer voting, rule violations, inactivity, or system-controlled criteria or cycles.

Exemplary embodiments of one or more players benched may suspend the player from scoring, point suppression, forfeiture of participation of one or more activities, reduce rank, reduce points, temporary exclusion from activities, or increased elimination potential.

In an exemplary embodiment, players may reverse or redeem the effects of benching through redemption tasks, reassessment by the evaluation module, viewer reinstatement, sponsor events, or predefined rule thresholds.

Immunity module 224 may be configured to reduce or overrise the chance of a player and/or group from being selected for penalty, benching, and/or elimination. For example, a player in first place of an activity may be immune from being eliminated in the next round or if a player had sufficient support provided through the viewer interaction module, the player may be spared from an elimination event.

The system may include or award an attribute, such as a golden ring, that indicates a protected competitive immunity artifact. When activated, the immunity artifact may allow a participant to override elimination, benching, scoring deductions, or combinations thereof. The elimination protection attribute may be generated randomly and given to one or more players, may be system generated based on the evaluation module, may be viewer awarded, may be sponsor activated, and/or may be earned by performing one or more higher-tier or additional activity generated through the activity module.

When an elimination protection attribute is activated by a player, the player may suspend or override an elimination decision, may override, reduce, or prevent application of penalty states or points, become immune during a scoring cycle, provide redistribution of weighting factors and/or ranking protection, or combinations thereof.

If two or more players have the same score, such as two or more players are tied, the system may be configured to break the tie. One or more features from the one or more modules may be used to break a tie. For example, a completion time may be used such that a player that performed an activity faster will win a tie. As another example, the difficulty level may be used such that a more difficult activity will receive the higher position and break the tie for the associated players. Other modules may also be used, such as, for example, the viewer interaction module, or evaluation module. Other attributes may also or alternatively be used to break the tie, such as, for example, historical performance of a player, such that the higher performance player would elevate in rank and break the tie. The historical performance may also include instances in which the tied players may have faced off head to head to determine that which player had historically won in a comparison of the players. The historical performance may also select the player with the higher score over the other tied player in previous rounds before the tie, such that if a player that was lower in rank elevated to become tied with a higher ranked player, the previously higher ranked player would remain higher than the player coming up the ranks. The activities module may also or alternative be used to generate another activity for the tied players to participate in a head to head tie breaking round. The system may also be configured to randomly select one player or the other to break a tie and elevate one tied player over the other player.

The system may permit players to be tied such that two or more players share the same ranking and/or may force a tie breaker as described herein. If the players remain tied and share the same ranking, the two or more players may share in the benefits and/or detriments associated with the rank. For example, if a high rank obtains an immunity, all of the players of the two or more tied players may receive the immunity. In an exemplary embodiment, if a benefit is obtained for two or more players that share the same ranking, the benefits may be duplicated and/or split between the tied players.

The system may rank players in the aggregation module 240 from the points earned by players from the activities module 204 and fantasy game module 202. The winner of the game may be based on the accumulated points such that the highest points results in the winning positions.

In an exemplary embodiment, the system may impose play-off rounds. The system may select that players above a certain rank or may put all players into the play-off. The elimination module 238 may be configured to control the playoff rule play. The players may be paired based on their rankings before entering the play-offs. The elimination module 238 may track the results from each round such that a winner of a round may participate in another round against another winner of a play-off round and the loser of the play-off round is eliminated from the play-offs.

In an exemplary embodiment, a player that finishes within a lowest scoring tier for a cycle may be eliminated. A player that accumulates insufficient cumulative points may be eliminated. A penalty/benching state may suppress scoring below a threshold. A player that fails to complete a required activity may be eliminated. If a player violates a rule or performs some disqualifying behavior, the player may be eliminated. In an exemplary embodiment, the evaluation module may analyze the actions of the player to assess and determine if a player may have violated a rule or performs a disqualifying behavior. The elimination module may be configured to eliminate one or more players at periodic times such as after each round. The system may also eliminate player groups and/or individual players.

In an exemplary embodiment, elimination may be overridden through the data of one or more modules. For example, the viewer interaction module may permit one or more spectators to vote to override an elimination decision by the system. Other options may also or alternatively be used to override an elimination, such as, for example, sponsor input through the sponsor activation module, a redemption opportunity that may be generated by the evaluation module 232 such as, for example, if a player is not performing at the same level as expected by previous actions of the player, other specific immunity rules that may be programmed into the elimination module.

The activities module may also include other features for enhancing engagement. For example, the system may be configured to generate daily activities for the players to participate. The system may provide activities at different periods. For example, the system may generate mini-games, such as games requiring less time and/or lower difficulty to complete and/or individual participation, on a daily basis, and/or mega-games, such as games requiring more time and/or higher difficulty to complete, and/or groups of players to compete together, on a weekly basis.

The system may also track details and provide players information about the status of the game. For example, the system may display one or more streaks of the players, the scores of the player, the activity status, or other attribute of the player(s) or activities.

The system may also permit or generate points for players in other ways. For example, the system may track points earned from daily activities, weekly activities, higher level activities, lower level activities, winning streaks, achievement badges that may convert to points, health points, leaderboard tiers, etc.

The system may also include a viewer module 242. The viewer modules 238 may be used to show or display the activities of the players. For example, exemplary embodiment may permit players to be remote from each other and/or may come together to perform the actions of the activity module. The viewer module may use a camera to receive images of the players as they undertake activities and/or may permit other players and/or spectators to observe the actions of players. The viewer module may therefore communicate with a display to display videos and/or images of players as they undertake activities.

In some implementations, the viewer module may also support a reality-style presentation of the competition, including episodic broadcasts, live or recorded streams, confessionals, highlight reels, or other narrative elements that permit viewers to follow player progress and participate through voting, commentary, or other interactive features.

The system 200 may also include an aggregation module 240 to combine the points and features of the fantasy game module 202 and the activities module 204. The aggregation module 240 may be the scoring amalgamation system for multi-layer, dynamic scoring for combining fantasy points, activity points, boost points, health points, or any combination of points shown and described herein.

In some embodiments, the aggregation module explicitly merges a fantasy pipeline associated with team member statistics and an activity pipeline associated with player-performed activities, thereby generating a dual-source total score that reflects both underlying professional performance and direct participation by the players.

The aggregation module 240 may be configured to score the game continuously as players perform activities or as actions are completed.

The aggregation module may further be configured to update one or more leaderboards in real time or near real time, providing users, commissioners, and viewers with current rankings, score breakdowns by category, streak indicators, and other status information for players and teams.

The system may be configured to include interconnected modules to perform one or more functions described herein. The system may permit players to earn points through the fantasy game, one or more activities, one or more additional point attributes, such as from the evaluation module, health module, viewer interaction module, boost module, activity scaling, sponsor module, penalty module, immunity module, or any combination thereof.

The system may be operated over a defined period of time, a season. The season may include multiple rounds comprising daily and/or weekly activities, weekly resets, cumulative scoring and/or carryovers, seasonal multipliers, ranking tiers, cutoff thresholds, playoff activities, championship scoring, or combinations thereof.

A season may culminate in any combination of a finale activity, multi-tier elimination, multi-stage scoring integration, grand total scoring, winner determination by cumulative game and finale scoring.

In a reality-style implementation, each season may be organized into episodes or cycles that correspond to one or more activities and scoring events, with eliminations, immunity awards, and activities presented as structured game moments that drive narrative progression and audience engagement.

In an exemplary embodiment, the system supports a method for variable scoring tables, weighted multipliers, artificial intelligence adjusted scoring, difficulty scaling, multi-tiered competitive logic, or combinations thereof. Scoring may depend on time based performance, completion accuracy, difficulty tiers, audience metrics, algorithmic scoring factors, or combinations thereof.

Exemplary embodiments of the modules shown and described herein collectively perform multi-domain scoring, providing real-time event tracking, adaptive ranking, elimination cycles, interactive audience participation, machine controlled through artificial intelligence performance verification, or combinations thereof,

The system may also include a validation and/or anti-fraud module 244. The validation/fraud module 244 may include login credentials, user verification, authentication security, user identity, and/or other security criteria to ensure the actions of the players are intentional and associated with the actual player. The validation/fraud module 244 may also be configured to validate the actions of the players during an activity. The validation/fraud module 244 may include one or more sensors to detect motion, locations, or other attribute to confirm the actions of the users as they perform activities to minimize cheating within the game.

Exemplary embodiments of the system shown and described herein may be used with players in a reality television show environment. The players may use the application to obtain or generate the scores for activities and may permit viewers to provide feedback for the players displayed on television. The activities module in this embodiment may permit scoring to occurred based on one or more episodes of the television show. The system may also permit live or delayed penalties or bonuses based on viewer participation, elimination round, immunity opportunities, sponsorship, spotlight moments or replays for the viewer, bonus points, super activities for the finale or end of a show, performance based confessionals or player interviews, or a combination thereof.

FIG. 3 illustrates an exemplary system for performing the game according to embodiments described herein. Exemplary embodiments of the game system described herein may include a computer, computers, electronic device, or electronic devices. As used herein, the term computer(s) and/or electronic device(s) are intended to be broadly interpreted to include a variety of systems and devices including personal computers 1004, laptop computers 1003, mainframe computers, servers 1005, set top boxes, digital versatile disc (DVD) players, mobile phone 1001, tablet, smart watch, smart displays, televisions, and the like. A computer can include, for example, processors, memory components for storing data (e.g., read only memory (ROM) and/or random-access memory (RAM), other storage devices, various input/output communication devices and/or modules for network interface capabilities, etc. For example, the system may include a processing unit including a memory, a processor, an analog-to-digital converter (A/D), a plurality of software routines that may be stored as non-transitory, machine-readable instruction on the memory and executed by the processor to perform the processes described herein. The processing unit may be based on a variety of commercially available platforms such as a personal computer, a workstation a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a remote server 1005 or memory 1006.

Exemplary embodiments of the game systems and methods described herein provide a processor, such as server 1005, configured to perform the functions described herein when computer instructions stored on memory 1006 are executed by the processor. The exemplary system is configured to perform any combination of the following features:
Providing and displaying a user interface for selecting team members from a group of available team members
Providing and displaying a user interface for identifying one or more players to form a game team and create a virtual team with a combination of players and team members
Wherein the team members comprise identities of persons that play in a sport or other activity that are on teams and in a physical league
Wherein the players are physical people joining the game according to embodiments described herein
Receiving team member statistics for each of the available team member
Wherein the statistics associated with the team members are determined based on performance in one or more physical games played within the sport or other activity in the physical league
Determining a virtual score based on the statistics associated with each of the selected team member
Creating one or more team activities to be performed by one or more players
Determining a physical score from the results of the one or more team activities performed by the one or more players
Determining an overall team score from the virtual score and the physical score
Ranking the game team based on the overall team score.

A user, such as the player and/or commissioner as described herein may access the system through a user interface displayed on a screen of an electronic device, such as on mobile device 1002, laptop 1003, computer 1004. The system may be accessed through a web browser on the electronic device and/or through an application downloaded and executed on the electronic device. A user 1001 may thereafter communicate with and/or engage in the game of the server 1005 through the electronic device.

Exemplary embodiments of the method of playing an electronic game, the electronic game having memory with machine readable instructions that is configured to perform functions when executed by a processor of the electronic game, the method includes presenting a user interface to a plurality of users with the electronic game to select a subset of team members from a group of available team members; receive a plurality of selections of the subset of team members from the group of available team members for each of a plurality of users, defining a specific team of the subset of team members for each of the plurality of users; receive statistics about the group of available team members after an activity is performed by any combination of the group of available team members; determine a virtual score for each of the plurality of users based on the statistics associated with the specific team for each of the plurality of users; select one or more activities to be performed by the plurality of users; receive information about the performance of the plurality of users; determine a physical score for each of the plurality of users based on the performance of the plurality of users; and determine team rankings of the specific team for each of the plurality of users.

The method according to embodiments described herein may also include the one or more activities to be performed by the plurality of users comprises any combination of racing, athletic event, workout, circuit training, exercise, trivia, puzzle, video game, or other game.

The method according to embodiments described herein may also include, wherein the one or more activities are competitive activities between the users and the physical score for each of the plurality of users is based on the performance of the plurality of users relative to the other of the plurality of users.

In an exemplary embodiment, the system may be configured to provide the users a user interface for conducting the activity. In an optional example, the system may be configured to present the users with a game such as trivia questions, puzzles, video game interface, etc. The system may be configured to permit the users to play the game and obtain a ranking of the users based on the performance of the game. The system may be configured to give an associated score for the ranking of the users.

The method according to embodiments described herein may also include, wherein the score is based on any combination of an amount of time for a user to complete the activity, a relative position in an outcome for a user relative to the other of the plurality of users, points earned for a performance according to game rules of the activity, number of repetitions.

The method according to embodiments described herein may also include, wherein the physical score is based on the relative position of the user relative to the other of the users where a first-place user obtains the highest physical score and a last place user obtains the lowest physical score.

The method according to embodiments described herein may also include, wherein a tie between more than one user is broken by a standoff between the more than one user in the tie and/or in extending the activity to determine a relative position between the more than one user in the tie.

The method according to embodiments described herein may also include, wherein the activity by any combination of the group of available team members is repeated periodically and the virtual score is determined after each activity.

The method according to embodiments described herein may also include, wherein the plurality of users performs one or more activities periodically and a physical score is determined after each activity.

The method described herein including the activities of the team members and the activities of the users may be repeated so that the physical score and/or the virtual score may be obtained after each of the activities. The method and system may determine a total score based on the virtual score and the physical score. The total score may be updated and may be based on the plurality of physical scores and the plurality of virtual scores. The user rankings may be based on the total score.

The method according to embodiments described herein may also include, wherein the team rankings are updated after each activity.

The method according to embodiments described herein may also include, wherein one user from the plurality of users is skipped for the activity and does not obtain a physical score for one repetition of the periodic activities.

The method according to embodiments described herein may also include, wherein the one user from the plurality of users participates in a next activity and obtains a physical score for the next activity after having skipped an activity.

The method according to embodiments described herein may also include, further comprising playoffs.

The method according to embodiments described herein may also include, wherein the ranking is based on a total score for each of the plurality of users and the total score is the summation of the virtual score and physical score for that user.

The method according to embodiments described herein may also include, further comprising playoffs in which a user of the plurality of users with the lowest total score is eliminated from a remaining round of activities after of the final activities of the playoffs until only a subset of users remain of the plurality of users.

A multi-domain scoring system shown and described herein integrates fantasy game points, activity points, boost points, health points, evaluation points, viewer points, sponsor activations, penalty states, immunity mechanisms, validation layers, and display the results in a cumulative leaderboard.

In some embodiments, the cumulative leaderboard functions as a unified scoring pipeline that merges virtual scores derived from team member statistics and physical scores derived from player activities into a single ranking output used for advancement, seeding, immunity determinations, and elimination decisions.

The system wherein activities comprise structured physical, mental, creative, digital, or health-based tasks.

A system converting biometric data into Health Points used for ranking.

A system wherein viewer interactions add, remove, or modify scoring.

A system wherein an artificial intelligence system may be configured to evaluate activities for authenticity, accuracy, difficulty scoring, and rule compliance.

A penalty state (‘Benching’) may reduce or suspend scoring eligibility.

An immunity artifact may be generated to override elimination outcomes.

Exemplary embodiments of the application may permit applicability across different platforms, mobile applications, TV, entertainment, gaming, education, fitness, corporate productivity, and real-world or virtual competitions requiring measurable outcomes.

Dynamic scoring may be provided to combine multiple scoring categories.

Artificial intelligence may be used to adjust ranking conditions under penalty or immunity states.

Exemplary embodiments of the system and methods described herein may be implemented through software operating on mobile devices, tablets, personal computers, wearable devices, and cloud-based servers. The platform may include modules for user registration, challenge assignment, data ingestion, real-time scoring, leaderboard updates, interactive controls, and cross-platform synchronization.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

Exemplary embodiments of the platform shown and described herein comprises: a graphical user interface (GUI) enabling participant and audience interaction; a cloud-based back-end server configured to receive, aggregate, and process activity data.

Exemplary embodiments may include Application Programming Interfaces (APIs) for interfacing with third-party data sources, including wearable health devices, streaming platforms, and social applications.

The platform may comprise automated scoring algorithms executing on a server or distributed computing environment.

The system may include optional machine-learning modules configured to generate, evaluate, and adjust activities, player results, points, or combinations thereof dynamically based on historical data and performance metrics.

Exemplary embodiments shown and described herein may include a scoring engine. The Scoring Engine constitutes a programmable, modular scoring architecture designed to assign quantifiable points (‘Activity Points’) to competitive, creative, biometric, cognitive, or digital tasks, identified as point attributes. The engine is capable of integrating multiple scoring inputs, including any combination of: Rank-based scoring, Difficulty scaling, Time-based performance modifiers, AI-evaluated skill metrics, Biometric or health-derived metrics, or audience or sponsor-triggered boosts.

Exemplary embodiments include system and methods wherein user engagement triggers a supplementary challenge activity upon reaching a defined threshold of audience input.

Exemplary embodiments include system and methods wherein sponsor actions activate temporary scoring multipliers or bonuses within the scoring engine.

Exemplary embodiments include system and methods wherein viewer or user input is aggregated to influence subsequent challenge configurations, scoring adjustments, activities, eliminations, penalties, benefits, or leaderboard updates.

Exemplary embodiments include system and methods that include a temporary variation system modifying challenge/activity conditions without altering core rules, scoring tables, or advancement mechanics.

In certain embodiments, this temporary variation system may be implemented as an activity event, during which scoring conditions are strategically altered for a limited duration while preserving the core scoring models and advancement mechanics of an overall game.

Exemplary embodiments include system and methods including a strategic method for temporarily removing a participant from scoring eligibility.

Exemplary embodiments include system and methods wherein a limited-use elimination override is provided to enable a participant to avoid removal from the competition.

Exemplary embodiments include system and methods having a system for converting biometric data into quantifiable competitive scoring.

Exemplary embodiments include system and methods using machine learning to create, evaluate, or adjust player rankings and/or scoring dynamically.

Exemplary embodiments include system and methods includes a software-implemented system enabling gameplay across mobile, web, wearable, and broadcast-integrated devices.

Exemplary embodiments include system and methods include applying activities as universal competitive structures across sports, entertainment, education, business, health, and social platforms.

Exemplary embodiments may comprise player(s) or participant(s) that may be real human user(s) who take part in the game or competition.

Exemplary embodiments may comprise team members that are real-world individuals whose actual performance statistics generate fantasy points.

Exemplary embodiments may comprise fantasy game module that includes a system component that stores team members, receives statistics, and calculates fantasy points.

Exemplary embodiments may comprise an activities module that includes a system component that manages and scores structured activities performed by players.

Exemplary embodiments may comprise fantasy points that are awarded from real-world athletic statistics.

Exemplary embodiments may comprise activity points that are awarded from player performance in structured activities.

Exemplary embodiments may comprise boost points that are additional points earned from viewer input, sponsor actions, achievements, streaks, or special events.

Exemplary embodiments may comprise health points that are derived from biometric or wellness data such as heart rate, steps, sleep, or exertion metrics.

Exemplary embodiments may comprise penalty state or benching which includes a temporary state in which a player's ability to earn points is reduced or suspended.

Exemplary embodiments may comprise an immunity artifact which includes a limited-use protection mechanism that prevents penalties, benching, or elimination.

Exemplary embodiments may comprise an activity event or scoring condition in which a temporary scoring variation that modifies weighting, difficulty, or time without changing core rules of the overall game.

Exemplary embodiments may comprise a unified leaderboard or cumulative leaderboard that combines ranking and aggregates all scoring categories into one total score.

Exemplary embodiments may comprise a season defining a competition period including multiple cycles, rounds, or episodes.

Exemplary embodiments may comprise episode(s), cycle(s), or round(s) which includes any defined scoring period such as daily, multi-daily, weekly, single-event, or season-based cycles, used for activities, scoring, penalties, boosts, activity events, or eliminations.

Exemplary embodiments may comprise challenge medium, structured challenge environment, or competitive environment that includes any platform or setting in which structured challenges occur, including mobile apps, web platforms, wearable devices, esports, fitness programs, workplaces, schools, live or virtual events, or broadcast media.

A scoring system for a competition game, the system including a fantasy module that lets users pick team members, receive sports statistics, and earn virtual points based on those statistics; an activities module that provides activities for users to perform, collects performance information, and awards activity points based on how they perform; a boost module that awards extra points from viewer votes, sponsor actions, or system-triggered events; a health module that adds points from fitness or wellness data; an evaluation module that applies rules or AI to assess how well users complete activities; an aggregation module that combines all point types into one total score for each user; and a leaderboard that displays rankings based on each user's total score.

A method for temporarily changing how points are awarded during a competition, the method including: detecting a condition that triggers a scoring change; starting an activity scoring period where one or more scoring rules or point values are changed; applying the activity scoring changes to virtual scores, physical scores, or total scores; selecting activities for users to complete; collecting information about user performance; awarding modified points during the activity period; and returning to normal scoring when the activity period ends.

A competition platform that runs a season or progression of gameplay rounds, the platform including: a game engine that manages repeated rounds where users perform activities, earn points, and continue in the game unless they fall below a threshold; a scoring engine that adds together virtual points, physical points, boost points, health points, and evaluation points; an elimination engine that removes one or more users based on scores or playoff results; a viewer system that lets the audience send boosts, votes, reactions, or other inputs that affect scoring or advancement; and a winner-selection component that determines a final winner based on total scores and advancement rules.

The system and method may include a scoring engine enhancement.

Activities may include running, workouts, circuits, exercise, trivia, puzzles, video games, or other challenges.

Activity points may be based on factors including time, repetitions, accuracy, or ranking.

Ties may be decided by an extra challenge or extended round.

Virtual points may be updated after each sports event.

Activity points may be updated after each user-performed activity.

The leaderboard may update after each activity or scoring cycle.

The system and methods shown and described herein may include activities, penalties, playoffs, advancements, or other modifications.

The activity scoring period may be triggered by viewer votes, sponsor actions, AI analysis, or time-based events.

Users may skip an activity and receive no points for that round.

A user who skips a round may participate in a later round and earn points.

Playoffs may use total scores made from virtual, physical, boost, health, and evaluation points.

Users with the lowest total scores may be eliminated until a final group remains.

Users can hold an immunity item that protects them from elimination for at least one round.

Exemplary embodiments of the systems and methods may include viewer interaction and game continuation.

Viewers can vote, react, comment, or send other feedback that affects gameplay.

Users may continue in the game without elimination if they meet certain scoring or advancement rules.

Exemplary embodiments of the systems and methods may include cloud, mobile, or other architecture.

Scoring may be processed using a cloud-based or distributed computing system.

A mobile application stored and executed on a mobile device may synchronize user activity, fitness data, or performance information with the scoring engine.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

The invention claimed is:

1. A method of playing an electronic game, the electronic game having memory with machine readable instructions that is configured to perform functions when executed by a processor of the electronic game, the method comprising:
present a user interface to a plurality of users with the electronic game to select a subset of team members from a group of available team members;
receive a plurality of selections of the subset of team members from the group of available team members for each of a plurality of users, defining a specific team of the subset of team members for each of the plurality of users;
receive statistics about the group of available team members after an activity is performed by any combination of the group of available team members;
determine a virtual score for each of the plurality of users based on the statistics associated with the specific team for each of the plurality of users;
select one or more activities to be performed by the plurality of users;
receive information about the performance of the plurality of users;
determine a physical score for each of the plurality of users based on the performance of the plurality of users; and
determine team rankings of the specific team for each of the plurality of users.

2. The method of claim 1, the one or more activities to be performed by the plurality of users comprises any combination of racing, athletic event, workout, circuit training, exercise, trivia, puzzle, video game, or other game.

3. The method of claim 2, wherein the one or more activities are competitive activities between the users and the physical score for each of the plurality of users is based on the performance of the plurality of users relative to the other of the plurality of users.

4. The method of claim 3, wherein the score is based on any combination of an amount of time for a user to complete the activity, a relative position in an outcome for a user relative to the other of the plurality of users, points earned for a performance according to game rules of the activity, number of repetitions.

5. The method of claim 3, wherein the physical score is based on the relative position of the user relative to the other of the users where a first-place user obtains the highest physical score, and a last place user obtains the lowest physical score.

6. The method of claim 5, wherein a tie between more than one user is broken by a standoff between the more than one users in the tie and/or in extending the activity to determine a relative position between the more than one user in the tie.

7. The method of claim 1, wherein the activity by any combination of the group of available team members is repeated periodically and the virtual score is determined after each activity.

8. The method of claim 7, wherein the plurality of users performs one or more activities periodically and a physical score is determined after each activity.

9. The method of claim 8, wherein the team rankings are updated after each activity.

10. The method of claim 9, wherein one user from the plurality of users is skipped for the activity and does not obtain a physical score for one repetition of the periodic activities.

11. The method of claim 10, wherein the one user from the plurality of users participates in a next activity and obtains a physical score for the next activity after having skipped an activity.

12. The method of claim 9, further comprising playoffs.

13. The method of claim 9, wherein the ranking is based on a total score for each of the plurality of users and the total score is the summation of the virtual score and physical score for that user.

14. The method of claim 13, further comprising playoffs in which a user of the plurality of users with the lowest total score is eliminated from a remaining round of activities after of the final activities of the playoffs until only a subset of users remain of the plurality of users.
